(19) United States
(12) Patent Application Publication
(10) Pub. No.: US 2025/0360454 A1
(43) Pub. Date: Nov. 27, 2025

(54) SOLID-STATE GAS SORPTION, STORAGE AND SEPARATION

(71) Applicant: Deakin University, Geelong, Victoria (AU)

(72) Inventors: Ying CHEN, Point Cook, Victoria (AU); Srikanth MATETI, Grovedale, Victoria (AU)

(21) Appl. No.: 18/874,729

(22) PCT Filed: Jun. 29, 2023
(86) PCT No.: PCT/AU2023/050602

§ 371 Date: Dec. 13, 2024

(30) Foreign Application Priority Data
Jun. 30, 2022 (AU) 2022901836
Feb. 23, 2023 (AU) 2023900477

(51) Int. Cl. B01D 53/06; B01J 20/02; B01J 20/28; B01J 20/30; B01J 20/34; C10L 3/10

(52) U.S. Cl. CPC B01D 53/06; B01J 20/0248; B01J 20/28004; B01J 20/3021; B01J 20/3483; C10L 3/101; B01D 2253/112; B01D 2256/245; B01D 2257/504; B01D 2257/7022; B01D 2259/40088

(57) ABSTRACT

The present invention relates to a method of promoting adsorption of one or more gases to solid particulate material, the method comprising ball milling the solid particulate material (i) in the presence of the one or more gases maintained at a pressure of at least 300 kPa, (ii) using a ratio of milling balls to solid particulate material of at least 60:1, and (iii) at an operating speed of at least 200 rpm.

### FIELD OF THE INVENTION

The present invention relates in general to solid-state gas sorption, storage and separation. More particularly, the invention relates to a method of promoting solid-state gas sorption that in turn can facilitate gas storage and separation.

### BACKGROUND OF THE INVENTION

Modern society has a long history of developing techniques for storing gases. For example, the basic storage of fuel gases dates back to the early 1800s.

Early techniques for storing gases include compression of gas into a vessel to produce compressed or liquefied gas. The compression storage of gases requires the use of specialised high-pressure vessels that to this day present drawbacks such as high cost and safety concerns.

More recent techniques being adopted for storing gases include so-called solid-state approaches whereby gas either chemically reacts with or physically adsorbed to a suitable solid substrate material. While such approaches do not suffer from their high-pressure counterparts, they too have drawbacks.

For example, so-called chemical reaction techniques are where the gas to be stored undergoes a chemical reaction with an adsorbent material to form new species such as oxides, nitrides and hydrides etc. While the gas does becomes adequately stored, its recovery requires significant energy (e.g. high temperature) input to promote a reversal of the chemical reaction and reformation/release of the gas. Furthermore, there are limited combinations of gases with viable chemically reactive adsorbent materials.

So-called physical adsorption techniques rely on the gas forming a physical association (e.g. via van der Waal forces) with the adsorbent material. While gas adsorbed in that way can be recovered with much less energy input (e.g. lower temperature), that technique is traditionally prone to affording a relatively low storage capacity.

Often associated with gas storage is a need for separating a mixture of gases. For example, in addition to the need for storing gases, an important requirement for petrochemical industries is the separation of gas mixtures. A common approach for separating mixtures of gases is the use of cryogenic distillation processes. However, cryogenic distillation is highly energy intensive and in such industries is reported to account for up to 15% of global energy consumption.

Accordingly, there remains an opportunity to develop alternative technology for promoting the storage and separation of gases that addresses one or more of the drawbacks associated with state-of-the-art technology.

### SUMMARY OF THE INVENTION

The present invention provides a method of promoting adsorption of one or more gases to solid particulate material, the method comprising ball milling the solid particulate material (i) in the presence of the one or more gases maintained at a pressure of at least 300 kPa, (ii) using a weight ratio of milling balls to solid particulate material of at least 60:1, and (iii) at an operating speed of at least 200 rpm.

While ball milling has long been used as a technique for comminuting solid material and/or promoting intimate mixing between two or more different materials, it has surprisingly now been found that ball milling when performed using the specified combination of parameters can promote high adsorption capacities of gases onto solid particulate material. Gravimetric adsorption capacities of greater than 1500 cm³/g can be achieved. The technique has been found to be highly efficient, cost-effective, environmentally sound, energy-efficient and is particularly well-suited for scale up. According to the unique method of the invention, solid particulate material is advantageously processed into an excellent solid-state gas storage material. Furthermore, the unique adsorption of gases that takes place in accordance with the method of the invention can advantageously be used to facilitate separating mixtures of gases.

Without wishing to be limited by theory, it is believed ball milling solid particulate material using the specified combination of operation parameters subjects the particulate material to a unique intensive energy process whereby gas molecules become efficiently adsorbed to the solid particulate material. The method according to the invention can advantageously be preformed without the gas undergoing chemical reaction with the solid particulate material and consequently the gas is not converted into a new species such as an oxide, nitride or hydride etc. Rather, it is believed the method advantageously promotes one or more forms of non-covalent bonding between the gas and solid particulate material that achieves gravimetric adsorption capacities approaching that of conventional chemical reaction techniques, but with the low energy gas release profile of conventional physical adsorption techniques.

Furthermore, a given gas is believed to uniquely bind to a given solid particulate material meaning that the binding affinity of other gas/solid particulate material combinations is different. Those different binding affinities in turn can be used to promote separation of gas mixtures.

Notably, it is believed the method in accordance with the invention does not promote a chemical reaction between the solid particulate material and the gas in the sense that a new molecular species is formed between the gas and the solid particulate material. In other words, gas molecules processed in accordance with the method of the invention are believed to remain molecularly intact. Without wishing to be limited by theory, it is believed that the ball milling method promotes physisorption (e.g. through van der Wall forces) and/or electrostatic/ionic binding of the gas molecules to the solid particulate material.

Surprisingly, it has now been found gas can be stored at high capacity and recovered using a relatively low energy (low temperature) input via a solid state storage technique using controlled ball milling.

In accordance with the invention, adsorption of the one or more gases to the solid particulate material is not provided by way of chemical reaction or covalent bond formation between the one more gases and the solid particulate material.

Accordingly, the gas and solid particulate material combinations contemplated for use in accordance with the invention are not intended to include those which inherently undergo chemical reaction (e.g. metal and hydrogen combinations).

The present invention may therefore also be described as a method of promoting adsorption of one or more gases to solid particulate material without a chemical reaction occurring between the one or more gases and the solid particulate material, the method comprising ball milling the solid particulate material (i) in the presence of the one or more gases maintained at a pressure of at least 300 kPa, (ii) using a weight ratio of milling balls to solid particulate material of at least 60:1, and (iii) at an operating speed of at least 200 rpm.

The present invention may also be described as a method of promoting non-covalent adsorption of one or more gases to solid particulate material, the method comprising ball milling the solid particulate material (i) in the presence of the one or more gases maintained at a pressure of at least 300 kPa, (ii) using a weight ratio of milling balls to solid particulate material of at least 60:1, and (iii) at an operating speed of at least 200 rpm.

By “non-covalent” adsorption is meant the one more gases become adsorbed to the solid particulate material via binding mechanisms other than covalent bond formation. In that way the gas remains molecularly intact.

Suitable solid particulate material for use in accordance with the invention include, but are not limited to, crystalline material having a layered structure such as boron nitride, graphite, and transition metal dichalcogenides such as molybdenum disulphide, tungsten disulphide, molybdenum diselenide, tungsten diselenide and molybdenum ditelluride and non-layered materials such as boron, iron, and silicon.

In one embodiment, the solid particulate material is selected from boron nitride, graphite, molybdenum disulphide, tungsten disulphide, molybdenum diselenide, tungsten diselenide, molybdenum ditelluride, boron, iron, and silicon.

In another embodiment, the solid particulate material is selected from boron nitride, graphite, molybdenum disulphide, tungsten disulphide, molybdenum diselenide, tungsten diselenide, and molybdenum ditelluride.

In yet a further embodiment, the one or more gases are selected from hydrogen, carbon dioxide, carbon monoxide, C₁-C₄ hydrocarbons, ammonia, nitrogen monoxide, nitrogen dioxide, sulphur dioxide and nitrogen.

In another embodiment, the ball milling produces as a product the solid particulate material having the one or more gases adsorbed thereto and that product is contained in a vessel to store the one or more gases.

The present invention also provides a method of solid-state storing one or more gases, the method comprising ball milling solid particulate material as described herein, wherein the method produces as a product the solid particulate material having the one or more gases adsorbed thereto and that product is contained in a vessel to store the one or more gases.

The product contained in the vessel can be processed to release the one or more gases adsorbed to the solid particulate material to thereby recover the one or more stored gases.

The one or more gases may also be described as being non-covalently bound to the solid particulate material.

The unique and differential adsorption of gases to the solid-state particulate material in accordance with the invention advantageously enables separation of a mixture of gases.

In one embodiment, the ball milling is conducted in the presence of a mixture of two or more gases and it produces as a product the solid particulate material having the mixture of gases adsorbed thereto, and that product is processed to selectively release at least one adsorbed gas from the solid particulate material to thereby separate the released gas from the mixture of two or more gases.

The present invention also provides a method of separating a mixture of two or more gases, the method comprising ball milling solid particulate material as described herein, wherein the ball milling produces as a product the solid particulate material having the mixture of two or more gases adsorbed thereto, and that product is processed to selectively release at least one adsorbed gas from the solid particulate material and thereby separate the released gas from the mixture of two or more gases.

In one embodiment, the product of the solid particulate material having the mixture of two or more gases adsorbed thereto is processed by increasing its temperature to selectively release at least one adsorbed gas from the solid particulate material.

In a further embodiment, the ball milling is conducted in the presence of a mixture of two or more gases and it produces as a product the solid particulate material having (i) at least one gas from the mixture of gases adsorbed thereto, and (ii) at least one gas from the mixture of gases not adsorbed thereto, to thereby separate the at least one gas that is not adsorbed from the mixture of two or more gases.

The present invention further provides a method of separating a mixture of two or more gases, the method comprising ball milling solid particulate material as described herein, wherein the ball milling produces as a product the solid particulate material having (i) at least one gas from the mixture of gases adsorbed thereto, and (ii) at least one gas from the mixture of gases not adsorbed thereto, to thereby separate the at least one gas that is not adsorbed from the mixture of two or more gases.

Additional aspects and features of the present invention are discussed in more detail below.

### BRIEF DESCRIPTION OF THE DRAWINGS

Embodiments of the invention will be now described with reference to the following non-limiting drawings, in which:

FIG. 1. Schematic illustrating high-energy ball milling action of the used high-energy ball mill.

FIG. 2. Gas adsorption capacity: (a) Hydrocarbon gas pressure reductions during ball milling and (b) Corresponding gravimetric uptake of the gases as a function of milling time. (c) The gravimetric capacity of BN for C₂H₄ as a function of milling time and intensity (different weight ratio of the milling balls to the BN as indicated). (d) Maximum gravimetric uptake of various gases after ball milling of BN for 20 hours (e) Carbon dioxide uptake capacity on various materials.

FIG. 3. Maximum adsorption capacity with 1 g of BN: a) pressure drop curve b) gravimetric capacity of 1 gram of BN milled in C₂H₄.

FIG. 4. Gas mixture separation: (a) g-FTIR spectra of the initial C₂H₂/CH₄ mixture and the remaining gas after milling for 2 hours. (b) g-FTIR spectra of pure C₂H₄ and C₂H₆, the initial C₂H₄/C₂H₆ gas mixture (20:80 by volume) and the remaining gas after milling for 2 and 4 hours. (c) g-FTIR spectra of initial CO₂/CH₄ mixture and remaining gas after 2.5 h and 5 h. (d) Gas Chromatograms of initial CO₂/N₂ gas mixture and remaining gas after 2.5 h and 5 h.

FIG. 5. (a) FTIR spectra of the BN milled for 2 hours in CH₄ (i) and C₂H₂ (ii), and mixture gas of C₂H₂+CH₄ (iii) (b) FTIR spectra of the BN milled in the gas mixture (C₂H₄ (20 vol %)+C₂H₆ (80 vol %)) for 2 hours (i), and the released gas from the BN milled after heating to 550° C. analysed using STA-FTIR hyphenated system (ii).

FIG. 6. (a) FTIR spectra of the initial BN powder and the BN samples after various milling in C₂H₄ and heating treatments. (b) Full FTIR spectra of the BN milled in different hydrocarbon gases. Enlarged FTIR spectra are showing the fingerprint range of hydrocarbon molecules.

FIG. 7. Pressure reduction during milling of (1) fresh BN in C₂H₄ (1) and (2-3) heated BN and repeated for three cycles.

FIG. 8. Nitrogen isotherms of BN milled in C₂H₄ (a) and CH₄ (b); (c) BET surface area change of the milled BN in two gases (C₂H₄, CH₄) as a function of milling time.

FIG. 9. Analysis of gas adsorption mechanisms: (a) SEM images and XRD patterns of BN samples milled in C₂H₄ and CH₄. (b) TGA curves of the BN samples after milling in C₂H₄ and CH₄. B Is, N Is, and C Is XPS spectra of the BN samples milled in C₂H₄ (c, d, e) and CH₄ (f, g, h).

FIG. 10. TEM images of the BN milled in C₂H₄ (a) and CH₄ (b); inset: SAED patterns.

FIG. 11. C₂H₄ gas uptake performance in hBN of different sizes.

FIG. 12. C₂H₄ gas uptake performance in hBN of different sizes.

FIG. 13. (a) Schematic of the ball milling and heating separation process for mixtures containing a single olefin gas and a single paraffin gas. (b) Proposed separation of olefin and paraffin gases by combined ball milling and heating.

The invention is also described with reference to the following non-limiting examples.

### DETAILED DESCRIPTION

The present invention provides a method of promoting adsorption of one or more gases to solid particulate material.

By the one or more gases undergoing “adsorption” or becoming adsorbed to the solid particulate material is meant gas molecules that make up the one or more gases become bound or adhere to the solid particulate material. In other words, the gas molecules remain molecularly intact and adhere to the solid particulate material without undergoing a chemical reaction. Without wishing to be limited by theory, it is believed the unique intensive energy milling process that operates according to the present invention promotes physisorption and/or electrostatic/ionic bonding of gas molecules to the solid particulate material.

Reference herein to the one or more gases being bound or adhered to the solid particulate material is therefore intended to mean the one or more gases are adsorbed to the solid particulate.

The method in accordance with the invention is not believed to promote a chemical reaction and formation of a covalent bond between gas molecules and the solid particulate material.

The method in accordance with the invention is therefore intended to exclude using solid particulate material that will chemically react with the one or more gases so as to form a covalent bond between the one or more gas molecules and the solid particular material.

Taking into account the non-chemical reaction requirement, there is no particular limitation of gases that can be used in accordance with the invention. Suitable gases also include those that do and do not undergo adsorption to the solid particulate material. As will be discussed in more detail below, while the invention must be performed using at least one gas that undergoes adsorption to the solid particulate material, non-adsorption of a gas to the solid particulate material can be used to facilitate separation of a mixture of gases.

The affinity of a given gas to undergo adsorption to the solid particulate material in accordance with the invention will vary not only depending on the nature of the specific gas but also the nature of the solid particulate material. Guidance on adsorption affinity of various gases to various solid particulate material is outlined below. In addition, such adsorption affinity of gases to solid particulate material can be readily established experimentally.

Examples of suitable gases that may be used in accordance with the invention include, but are not limited to, hydrogen, carbon monoxide, carbon dioxide, C₁-C₄ hydrocarbons, nitrogen monoxide, nitrogen dioxide, sulphur dioxide, ammonia and nitrogen.

Examples of suitable C₁-C₄ hydrocarbons, such as C₁-C₂ and C₁-C₃ hydrocarbons include, but are not limited to, CH₄, C₂H₂, C₂H₄, C₂H₆, C₃H₆, C₃H₈, C₄H₈ and C₄H₁₀.

There is no particular limitation on solid particulate material that can be used in accordance with the invention provided (i) they can undergo adsorption of at least one gas, and (ii) do not chemically react with the one or more gases so as to form a covalent bond between the one or more gas molecules and the solid particular material.

The solid particulate material may take any shape and, for example, may be in the form of substantially spherical particles, sheet like particles, fibres and rod/wire like particles.

Examples of suitable material from which the solid particulate material may be derived includes, but is not limited to, crystalline material having a layered structure such as boron nitride, graphite, and transition metal dichalcogenides such as molybdenum disulphide, tungsten disulphide, molybdenum diselenide, tungsten diselenide and molybdenum ditelluride and non-layered materials such as boron, iron, and silicon.

The process of ball milling in accordance with the invention inherently comminutes the solid particulate material and increases its surface area. Provided the solid particulate material can be suitably ball milled, there is no particular limitation on the size of the particulate material that can be used.

Generally, the average particle size of the solid particulate material before being ball milled will range from about 1 μm to about 5 mm.

Generally, the average particle size of the solid particulate material after being ball milled will range from about 10 nm to about 100 μm.

An important feature of the present invention is the application of ball milling.

Using the specified combination of operational parameters, the present invention can advantageously be performed using conventional ball milling equipment.

Suitable ball milling equipment includes, but is not limited to, planetary ball mills, horizontal ball mills and vertical ball mills.

Those skilled in the art will appreciate ball milling equipment will include a milling container/jar and milling balls. There is no particular limitation on the material from which the milling container and balls are made provided they can withstand operating parameters and are substantially inert toward the reagents being processed.

Suitable milling containers include, but are not limited to, those made from stainless steel, zirconia, nylon, polytetrafluoroethylene and agate.

Suitable milling balls include, but are not limited to, those made from silicon carbide, stainless steel, hardened steel, zirconia and agate.

The size of the milling containers and balls used can be readily adjusted by those skilled in the art to suit the scale of the operation. The invention can advantageously be performed at lab, pilot and industrial scale.

In one embodiment, the milling container has a volume ranging from about 25 ml to about 1000 L.

Those skilled in the art will be able to readily select the size of the milling balls to suit the task at hand, including taking into account the volume of the milling container and the required ratio of milling balls to solid particulate material (discussed below).

In one embodiment, the milling balls have a diameter ranging from about 1 mm to about 200 mm.

There are at least three ball milling operation parameters that are collectively required in order to promote the desired adsorption of the one or more gases to the solid particulate material.

In accordance with the invention, the solid particulate material is ball milled (i.e. undergoes ball milling) in the presence of the one or more gases maintained at a pressure of at least 300 kPa. In other words, to promote the desired adsorption of the one or more gases ball milling is conducted in an atmosphere of one or more gases at a pressure of at least 300 kPa. If required, gas can be introduced into the ball mill during operation to maintain the required pressure.

In one embodiment, the one or more gases is maintained at a pressure of at least about: 400, 500, 600, 700 or 800 kPa.

In a further embodiment, the one or more gases is maintained at a pressure ranging from at least about 300 kPa to about 30,000 kPa, 400 kPa to about 30,000 kPa, 500 kPa to about 30,000 kPa, 600 kPa to about 30,000 kPa, 700 kPa to about 30,000 kPa, or 800 kPa to about 30,000 kPa.

The one or more gases can be introduced into the ball milling apparatus to provide for the required pressure using techniques known in the art.

As the ball milling operation proceeds the gas pressure in the ball milling apparatus will generally progressively reduce as the one or more gases undergo adsorption to the solid particulate material. The gas pressure can be readily monitored and re-pressurised back to at least 300, 400, 500, 600, 700 or 800 kPa if and as required.

In accordance with the invention, the solid particulate material is ball milled using a weight ratio of milling balls to solid particulate material of at least 60:1. That required weight ratio can be readily determined using conventional weight measuring equipment.

In one embodiment, the weight ratio of milling balls to solid particulate material is at least about 70:1 or about 80:1, or about 90:1, or about 100:1, or about 120:1, or about 150:1.

In one embodiment, the weight ratio of milling balls to solid particulate material ranges from at least 60:1 to about 300:1, for example form about 70:1 to about 300:1, or from about 80:1 to about 300:1, or from about 90:1 to about 300:1, or from about 100:1 to about 300:1, or from about 120:1 to about 300:1, or from about 150:1 to about 300:1.

When considering the weight ratio of milling balls to solid particulate material, the volume of the milling container and the number of milling balls may also need to be taken into account to ensure there remains sufficient space within the milling container to promote intensive energy impact from the milling balls onto the solid particulate material. Generally, the size of the milling balls will be selected to provide for the required weight ratio of milling balls to solid particulate material such that from about 4 to about 20 milling balls are used.

In one embodiment, from about 4 to about 20 milling balls are used.

In accordance with the invention, the solid particulate material is ball milled in the presence of the one or more gases at an operating speed of at least 200 rpm.

In one embodiment, the operating speed is at least about 250 rpm, or at least about 300 rpm, or at least about 400 rpm, or at least about 600 rpm.

In one embodiment, the operating speed ranges from at least 200 rpm to about 600 rpm, for example from about 250 rpm to about 600 rpm, or from about 300 rpm to about 600 rpm, or from about 400 rpm to about 600 rpm.

While ball milling has long been used as a technique for comminuting solid material and/or promoting intimate mixing between two or more different materials, it has surprisingly now been found that ball milling when performed using the collective of specified milling parameters imparts milling energy that promotes high adsorption capacities of gases onto solid particulate material. The technique has been found to be highly efficient, cost-effective, energy-efficient and is particularly well-suited for scale up. By promoting excellent gravimetric adsorption capacities, the gas adsorbed solid particulate material product produced in accordance with the present invention functions as an excellent solid-state gas storage material. That product has advantageously been found to be stable at room temperature and pressure in the sense the bound one or more gases can remain bound to the solid particulate material at room temperature (i.e. about 25° C.) and room pressure (i.e. about 1 atm).

Without wishing to be limited by theory, it is believed the collective specified ball milling operation parameters subjects the particulate material to a unique intensive energy process whereby gas molecules become physisorped and/or electrostatically bound to the solid particulate material. That adsorption process is advantageously believed to uniquely bind a given species of gas molecule to a given solid particulate material meaning that the binding affinity of other gas/solid particulate material combinations is different. As discussed in more detail below, those different binding affinities in turn can be used to promote separation of gas mixtures.

The method in accordance with the invention can advantageously produce as a product solid particulate material having a gas adsorption gravimetric capacity of at least 300, or at least 400, or at least 500 or at least 600, or at least 700, or at least 800, or at least 900, or at least 1000, or at least 1100, or at least 1200, or at least 1300, or at least 1400, or at least 1500 cm³/g.

The adsorption gravimetric capacity of the product in accordance with the method of the invention can vary depending upon the nature of the gas and solid particulate material. Despite such variation, the method has advantageously been found to afford substantially higher adsorption gravimetric capacities for a given combination of gas and solid particulate material relative to values obtained by conventional techniques.

For example, the present invention can provide boron nitride solid particulate material having an adsorption gravimetric capacity for CH₄ of at least 580 cm³/g, for C₂H₂ of at least 300, or 400, or 500, or 600, or 700 cm³/g, for C₂H₄ of at least 200, or 400, or 600, or 800, or 1000 cm³/g, for C₂H₆ of at least 200, or 300, or 400, or 500, or 600 cm³/g, for CO₂ of at least 800, or 900, or 1000, or 1100, or 1200 cm³/g, for NH₃ at least 400, or at least 500, or at least 600 cm³/g, and for H₂ of at least 1300, or 1400, or 1500 cm³/g.

A reference to adsorption gravimetric capacity or simply gravimetric capacity herein is a measured parameter of solid particulate material ball milled in accordance with the present invention that is determined according to equation 1:

$$n = \frac{P \cdot V}{R \cdot T} \qquad ( 1 )$$

where n is the number of moles, P is the pressure, V is the volume of the ball milling container, R is gas constant, which is 8.314, T is temperature. The number of moles converted to litres is then divided by grams of solid particulate material used in the ball mill.

The measured adsorption gravimetric capacity of a given solid particulate material and gas combination has been found increase with ball milling time. However, the solid particulate material eventually reaches a saturation point past which further ball milling time does not appreciably increase its gravimetric capacity. That said, in addition to providing overall higher gravimetric capacities attainable by conventional means, for a given period of ball milling time the method in accordance with the present invention also advantageously produces solid particulate material having higher gravimetric capacities attainable by conventional means.

The amount of time required to undertake ball milling can vary depending upon the nature of the solid particulate material and the one or more gases and also if the aim is to reach saturation sorption gravimetric capacity of the solid particulate material.

Generally, ball milling will be performed over time period ranging from about 2 hours to about 30 hours.

In one embodiment, the one or more gases are maintained at a pressure of at least 300 kPa for at least 2 hours, or at least 3 hours, or at least 4 hours, 5 hours, 6 hours, or at least 10 hours, or at least 15 hours, or at least 20 hours, at least 25 hours, or at least 30 hours.

A particular advantage of the present invention is that higher adsorption gravimetric capacities can be achieved not only relative to using conventional techniques, but also in a shorter timeframe than can be achieved using conventional techniques.

As the gas adsorbed product produced in accordance with the invention is stable at room temperature and pressure in the sense the bound one or more gases can remain bound to the solid particulate material at room temperature (i.e. about 25° C.) and room pressure (i.e. about 1 atm), the so formed product is particularly well suited as a medium for the storage of gas. The so formed product of solid particulate material having the one or more gases bound thereto and that product can be readily contained in a vessel to store the one or more gases.

The present invention therefore also provides a method of solid-state storing one or more gases, the method comprising ball milling solid particulate material (i) in the presence of the one or more gases maintained at a pressure of at least 300 kPa, (ii) using a ratio of milling balls to solid particulate material of at least 60:1, and (iii) at an operating speed of at least 200 rpm, wherein the method produces as a product the solid particulate material having the one or more gases adsorbed thereto and that product is contained in a vessel to store the one or gases.

As the product produced in accordance with the invention as the aforementioned stability, there is no particular limitation on the type of vessel that may be used contain the product and thereby store the one more gases.

However, if the storage vessel is also to be used as a vessel in which the one or more bound gases are to be released from the solid particulate material (e.g. to recover the gas), that vessel may require certain properties that make it suitable for undergoing the release process.

Despite the product produced in accordance with the invention having the aforementioned stability, the adsorbed one or more gases may nevertheless be readily released from the solid particulate material. For example, one or more gases adsorbed to the solid particulate material can be released therefrom simply by applying heat to the gas adsorbed solid particulate material. As the one or more gases are not covalently bound to the solid particulate material, the gas adsorbed to the solid particulate material can be released using relatively low energy input.

In one embodiment, the product contained in the vessel is heated in order to release the one or more gases adsorbed to the solid particulate material.

The product contained in the vessel may be heated to a temperature ranging from about 50° C. to about 500° C. to promote release of the one or more gases adsorbed to the solid particulate material.

The unique and differential adsorption of gases to the solid-state particulate material in accordance with the invention advantageously enables separation of a mixture of gases.

Where the method in accordance with the invention involves adsorption of two or more gases, those gases will have different binding affinities to the solid particulate material. In particular, while each gas will become adsorbed to the solid particulate material at least one gas will have a stronger binding affinity for the solid particulate material than the other. For example, it has been found that boron nitride exhibits the following adsorption affinity CH₄ <C₂H₆<C₂H₄<C₂H₂, indicating that boron nitride has a stronger adsorption affinity for olefin gases (C₂H₂ and C₂H₄) than for paraffin gases (CH₄ and C₂H₆). That difference in binding affinity enables the selective release of a gas from the solid particulate material, the practical effect of which advantageously enables the selectively released gas to be separated from the adsorbed mixed gas composition on the solid particulate material.

The selective release of a given gas species from the solid particulate material can readily be achieved simply by subjecting it to one or more processing steps. Such process steps might include heating the solid particulate material as herein described. For the purpose of the selective release of a particular gas species, compared with the bulk release of all adsorbed gas species, any given heating adjustments made to promote gas release may need to be conducted in a controlled manner. Such controlled heating adjustment to promote selective gas release from the solid particulate material can be readily performed by those skilled in the art.

By one or more gases being “separated” from a mixture of gases in the context of the present invention is meant one or more gases are adsorbed to be solid particulate material and one or more other gases are not adsorbed to the solid particulate material. In other words, the one or more gases adsorbed to the solid particulate material in effect form part of solid-state matter and the one or more gases not adsorbed to the solid particulate material remain in the gaseous state. The binding and non-binding of those gas species give rise to a separated state of gases.

In one embodiment, the ball milling is conducted in the presence of a mixture of two or more gases and it produces as a product the solid particulate material having the mixture of gases adsorbed thereto, and that product is processed to selectively release at least one adsorbed gas from the solid particulate material to thereby separate the released gas from the mixture of two or more gases.

Accordingly, the present invention also provides a method of separating a mixture of two or more gases, the method comprising ball milling solid particulate material (i) in the presence of the mixture of two or more gases maintained at a pressure of at least 300 kPa, (ii) using a ratio of milling balls to solid particulate material of at least 60:1, and (iii) at an operating speed of at least 200 rpm, wherein the ball milling produces as a product the solid particulate material having the mixture of two or more gases adsorbed thereto, and that product is processed to selectively release at least one adsorbed gas from the solid particulate material and thereby separate the released gas from the mixture of two or more gases.

Advantageously, the energy input requirements to promote separation of one or more gases from the gas adsorbed solid particulate material is substantially less than conventional means, such as cryogenic distillation, used for separating gases.

While performing the present invention is predicated on one or more gases undergoing adsorption to the solid particulate material, the invention also takes advantage of a situation where one or more gases do not undergo adsorption or have low adsorption kinetics to the solid particulate material and therefore do not become adsorbed to the solid particulate material.

For example, where a mixture of two or more gases used in accordance with the invention comprises one gas that has little or no adsorption affinity to the solid particulate material, performing the method of the invention will inherently promote separation of that gas mixture by that one gas not becoming adsorbed to the solid particulate material while the remaining one or more gases become adsorbed to the solid particulate material. In that case, gas separation is achieved simply by performing the method of the invention and without the need for necessarily conducting a dedicated gas release step.

In one embodiment, the ball milling is conducted in the presence of a mixture of two or more gases and it produces as a product the solid particulate material having (i) at least one gas from the mixture of gases adsorbed thereto, and (ii) at least one gas from the mixture of gases not adsorbed thereto, to thereby separate the at least one gas that is not adsorbed from the mixture of two or more gases.

The present invention further provides a method of separating a mixture of two or more gases, the method comprising ball milling solid particulate material (i) in the presence of the mixture of two or more gases maintained at a pressure of at least 300 kPa, (ii) using a ratio of milling balls to solid particulate material of at least 60:1, and (iii) at an operating speed of at least 200 rpm, wherein the ball milling produces as a product the solid particulate material having (i) at least one gas from the mixture of gases adsorbed thereto, and (ii) at least one gas from the mixture of gases not adsorbed thereto, to thereby separate the at least one gas that is not adsorbed from the mixture of two or more gases.

In one embodiment, the method in accordance with the present invention is used to separate CH₄ from C₂H₂, or C₂H₄ from C₂H₆, or CO₂ from CH₄, or CO₂ from N₂, or H₂ from N₂, or H₂ from CH₄, or C₂H₂ from C₂H₆, or C₂H₄ from CH₄, or H₂ from NH₃.

### EXAMPLES

### Example 1—Ball Milling, Materials and Gases

Hexagonal boron nitride (BN) powder (PT110 grade, 99% purity, particle size ˜20 μm) purchased from Momentive Performance Materials Inc. Graphite (particle size ˜15 μm),

Iron (particle size ˜85 μm), Boron (particle size ˜5 mm), MoS₂ (particle size ˜6 μm), Silicon (particle size ˜2 mm), purchased from Sigma Aldrich.

Hydrocarbon gasses including acetylene (C₂H₂), ethylene (C₂H₄), ethane (C₂H₆), methane (CH₄), ammonia (NH₃), hydrogen (H₂), Carbon dioxide (CO₂), nitrogen (N₂) of 99.99% purity were purchased from Coregas Pty Ltd, Australia.

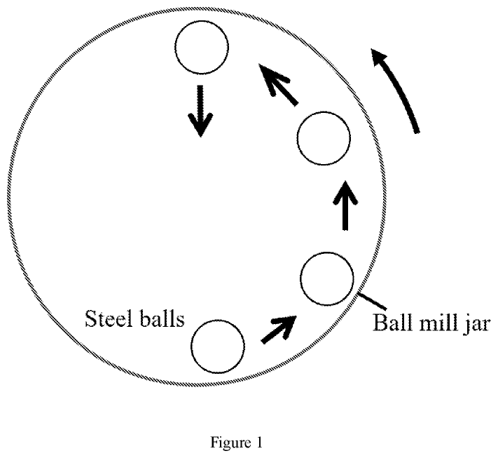

A vertical planetary ball mill (FIG. 1) was used in the examples. The milling jar/container has a pressure valve allowing atmosphere control. The gas pressure was measured by a gas gauge attached to the jar. The jar was loaded with 2-4 g of the material in each experiment. The jar was then evacuated, purged with Ar three times, and finally filled with the gas(es) of interest with a starting pressure of 400 kPa. The rotating speed of the ball mill was 160-600 rpm.

### Example2—Characterization

After ball milling, the gas adsorbed solid particulate material samples were collected in the argon-filled glove box and stored. For FTIR and TGA experiments, a small amount of sample is taken from the glove box and immediately tested to avoid contamination.

Sample morphology was examined using scanning electron microscopy (SEM) with a Hitachi S4500 Zeiss Supra 55VP instrument operated at 3 to 10 kV.

Thermal gravimetric analysis (TGA) was carried out using a TA Q50 instrument under 40 ml/min argon flow. The heating rate was 25° C./min.

The crystalline structure of samples was investigated using X-ray diffraction (XRD) with a PANalytical X′pert powder system (Cu Kα radiation λ=0.15418 nm) operated at 40 kV with a 30 mA current.

For BET nitrogen adsorption isotherms, samples were degassed at 110° C. for 4 hours to clean the surface, then performed the BET analysis. Pore size distribution is calculated by Barrett-Joyner-Halenda (BJH) desorption. Ball milled BN samples were heated in a tube furnace in an argon atmosphere to 700° C. with a heating rate of 25° C./min to remove adsorbed gas molecules. These samples further use for BET tests.

Chemical compositions of various samples were investigated on a Thermo Scientific κ-Alpha instrument (monochromatic Al Kα radiation). The binding energy (B.E) in each case, that is, core levels and valence band maxima, were corrected using an internal reference peak of C 1 s peak centred at 284.5 eV. Thermo Advantage software has been employed to deconvolute the core level spectra.

Fourier transform infrared spectroscopy (FTIR) was used to examine gas molecules. Powder samples were tested using a Bruker Vertex 70 infrared spectrometer in attenuated total reflection mode. The gas samples were analysed using two different FTIR systems: (1) Gas samples were analysed using a Perkin Elmer (Spectrum 100 model) FTIR system connected with a gas-cell. The FTIR data were collected in the range of 4000-600 cm⁻¹ at a resolution of 1 cm⁻¹. (2) the gas released from the milled BN samples via heating treatment was examined using hyphenated simultaneous thermal analysis-Fourier transform infrared spectroscopy (STA-FTIR), Perkin Elmer STA 8000 and Perkin Elmer Frontier FTIR system via a transfer line hyphenation using TL9000 interface. The measurements were carried out using approximately 5 mg of milled material, which was heated from 30 to 600° C. at a heating rate of 25° C./min. The released gas was immediately transferred to STA-FTIR through the transfer lines (balanced flow evolved gas analyser, TL9000). The FTIR data were collected in the range of 4000-600 cm⁻¹ at a resolution of 4 cm⁻¹.

### Example 3—Gas Storage/Gas Uptake

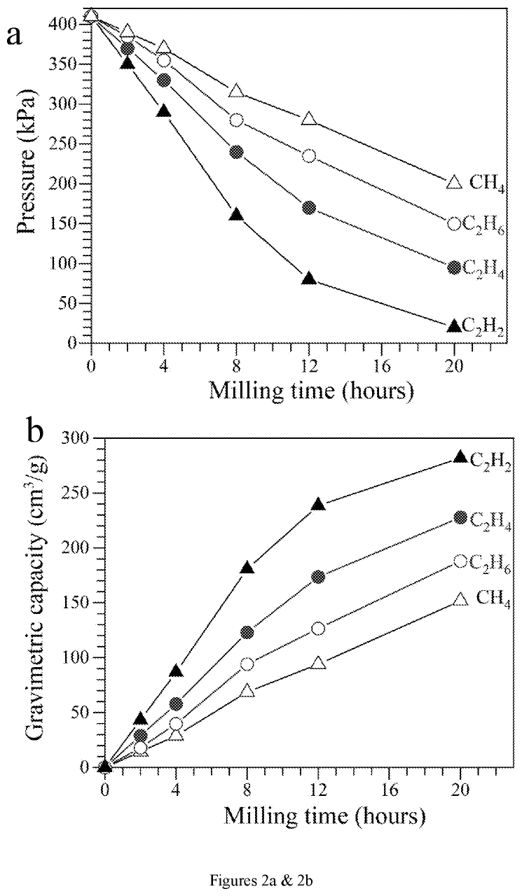

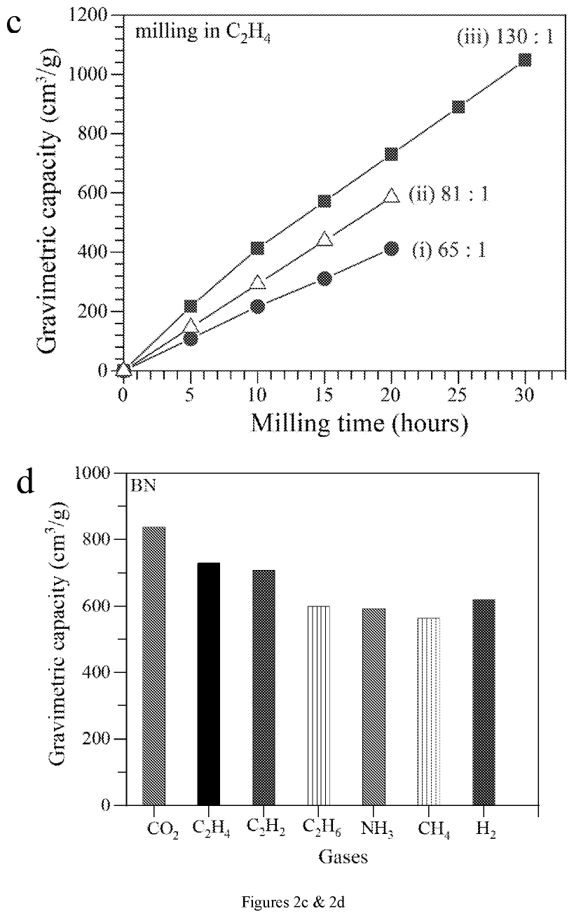

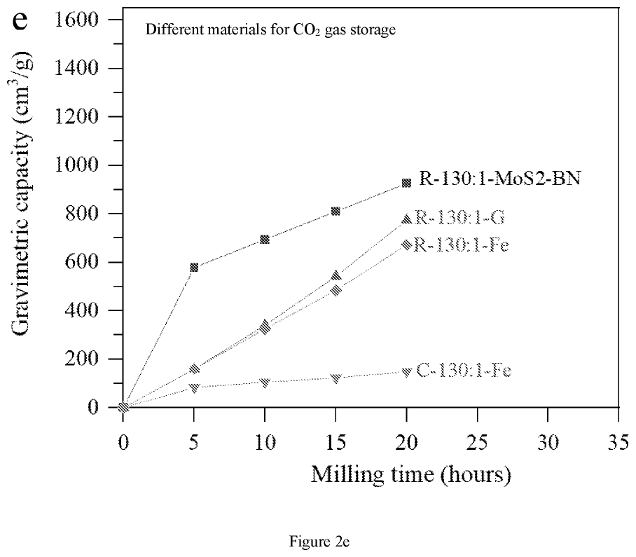

The gas did not adsorb onto the BN powder without milling action and no pressure change was observed. Once milling was initiated, a significant pressure reduction was observed due to gas adsorption, as displayed in FIG. 2a. In the sealed milling reactor, the pressure of alkyne gas of acetylene (C₂H₂) decreased from 400 to 20 kPa within 20 hours, which suggests that almost all C₂H₂ gas had adsorbed onto the BN. For olefin gas of ethylene (C₂H₄), the pressure decreased to 95 kPa after 20 hours of milling under the same conditions. Relatively slow pressure reduction was recorded for two paraffin gases (CH₄ and C₂H₆).

The corresponding gravimetric capacities for gas adsorption of four hydrocarbon gases as a function of milling time are displayed in FIG. 2b. After 20 hours of continuous milling, 282 cm³/g C₂H₂ and 228 cm³/g C₂H₄ were adsorbed onto the BN powder. The uptake capacities for paraffin gases (ethane and methane) were lower: 188 cm³/g for ethane (C₂H₆) and 152 cm³/g for methane (CH₄). FIG. 2b shows that the capacity curves do not flatten by 20 hours, suggesting that the gas adsorption did not saturate after 20 hours.

With further milling, gas adsorption continued at a decreased adsorption rate due to the reduced gas pressure in the sealed milling reactor (FIG. 2a).

To maintain a high adsorption rate, the milling reactor was refilled with the fresh gas (to at least 400 kPa) every five hours during the milling process.

A much higher adsorption capacity (412 cm³/g) of C₂H₄ was achieved after milling for 20 hours when the C₂H₄ was refilled at 5, 10 and 15 hours (FIG. 2c (i)). The adsorption rate was further increased by increasing the milling intensity via varying the weight ratio of the milling balls to BN. The higher milling intensity provides more energy into BN and accelerates reaction kinetics during milling. When the weight ratio increased from 65:1 to 81:1 and 130:1, the adsorption capacities after 20 hours increased to 585 and 730 cm³/g, respectively (FIG. 2c (ii) and (iii)).

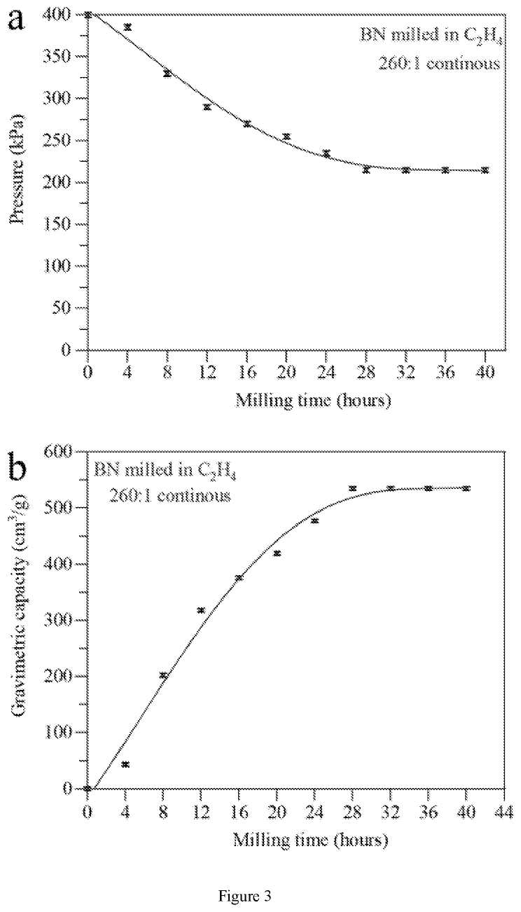

Extending the milling treatment can also increase the adsorption. For example, prolonged milling in C₂H₄ gas to 30 hours resulted in the adsorption capacity reaching 1048 cm³/g (FIG. 2c (iii)). Even under mild milling conditions, i.e., 20 hours of milling and a weight ratio of 130:1, the milling treatment with three gas refills produced an uptake capacity (FIG. 2d) of 708 cm³/g for C₂H₂. The total adsorption of CH₄ was 564 cm³/g after 20 hours of milling. The uptake capacity for C₂H₆ was 600 cm³/g. The curves in FIG. 2c show that C₂H₄ gas adsorption maintains a high adsorption rate and was not saturated by 30 hours. If the starting BN is reduced to 1 g, a saturated gas adsorption of 534.9 cm³/g was found after 28 hours of milling (FIG. 3).

Therefore, adsorption capabilities are believed to depend on the adsorption testing conditions (i.e., gas pressure, BN, milling intensity and time). Even under average ball milling conditions (e.g. 4 g of BN under the milling for 20 hours in sufficient gas) BN nanosheets have achieved the higher uptake capacities for olefin and alkyne, ammonia, hydrogen and carbon dioxide gases over all other materials. Gas storage is further enhanced by refilling the gas to 400 kPa for every 5 hours until total milling time of 20 hours. BN stored (FIG. 2d) 838.5 cm³/g of CO₂, 730.1 cm³/g of C₂H₄, 708.4 cm³/g C₂H₂, 600 cm³/g of C₂H₆, 592.7 cm³/g of NH₃, and 563.8 cm³/g of CH₄, 620 cm³/g of H₂. It is worth to note, these gravimetric capacities of gases are not saturated yet, further gas can be stored by extended milling or fine-tuning ball milling parameters. Further various materials have been used to store carbon dioxide (FIG. 2e).

Under the same milling conditions, the adsorption rates varied among the different gases investigated (FIG. 2b). The highest adsorption rate observed was 21.6 cm³ g⁻¹ h⁻¹ for C₂H₂, which is almost 3 times faster than that for CH₄ (7.2 cm³ g⁻¹ h⁻¹). The trend in adsorption capacities was CH₄<C₂H₆<C₂H₄<C₂H₂, indicating that BN exhibited a stronger affinity for olefin gases (C₂H₂ and C₂H₄) than for paraffin gases (CH₄ and C₂H₆). The large differences in adsorption capacities and adsorption rates for these hydrocarbon gases suggest that they can be separated via selective adsorption by BN under controlled milling conditions. Further, the ball milling process should be applicable for separating other gas groups with different adsorption rates.

### Example 4—Separation of Various Gas Mixtures

This example demonstrates the following gas mixture separation includes C₂H₂/CH₄; C₂H₄/C₂H₆; CO₂/N₂; CO₂/CH₄

High-purity CH₄ gas is considered a relatively clean fuel and used as an important feedstock in the production of various chemicals; small amount of C₂H₂ often co-exists with CH₄ and thus needs to be removed. To test the capability of the method to separate such gases, a mixture of C₂H₂ (20 vol %) and CH₄ (80 vol %) was added to a milling reactor containing 4 gram of BN and 4 milling balls at 410 kPa. After milling for 2 hours with a weight ratio of 65:1, the pressure of the gas mixture decreased to 350 kPa, indicating that gas adsorption occurred. The remaining gas in the milling reactor was collected in a gas cell and analyzed with gas-phase FTIR (g-FTIR).

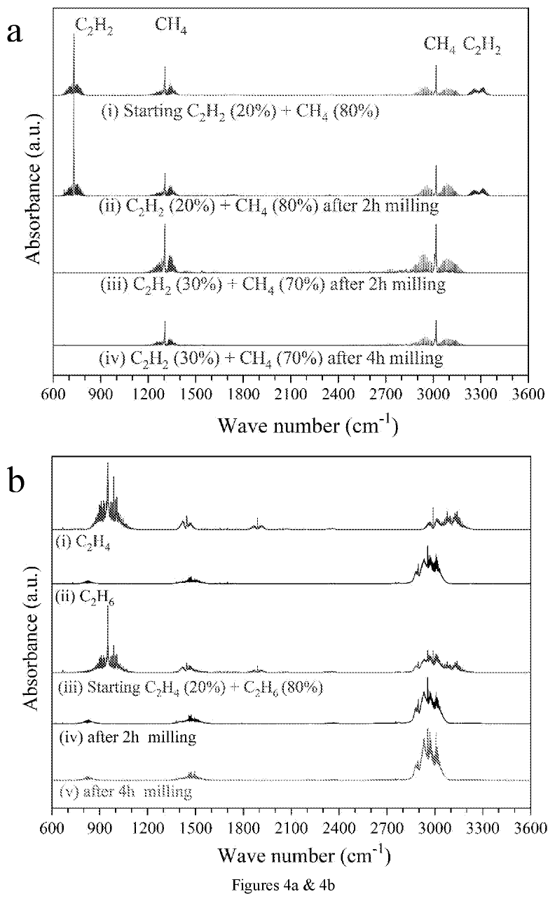

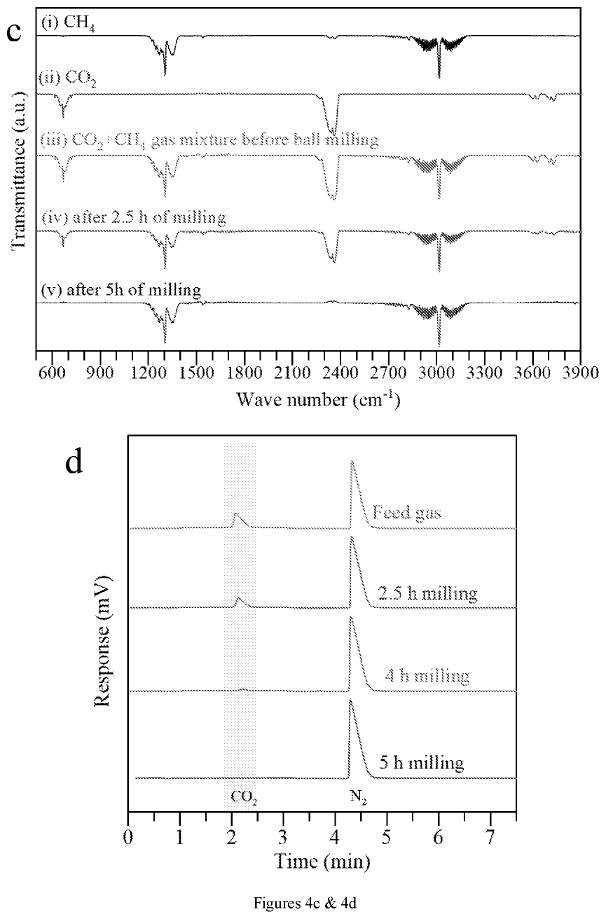

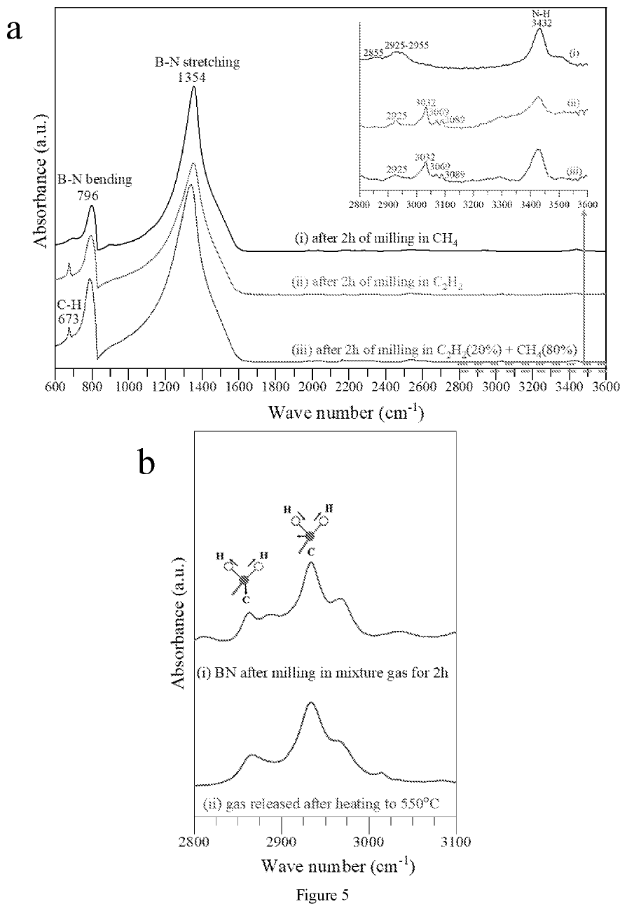

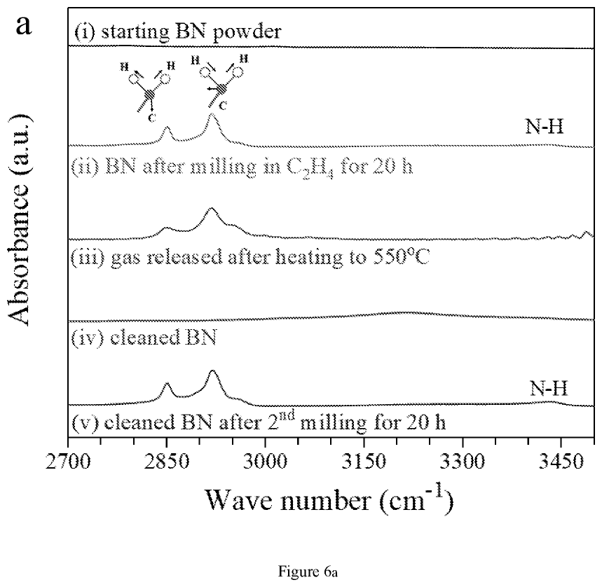

The g-FTIR spectrum of the initial gas mixture (FIG. 4a (i)) indicated the presence of both gases, but only CH₄ was detected in the remaining gas after milling for 2 hours (FIG. 4a (ii)). The spectral results after milling for 4 hours confirmed that C₂H₂ was completely removed from the gas mixture. C₂H₂ adsorption onto the milled BN was confirmed by FTIR analysis (FIG. 5a). A longer milling duration was required to remove C₂H₂ at a higher concentration.

For a mixture containing 30 vol % C₂H₂ and 70 vol % CH₄, at least 4 hours of milling was required to fully remove C₂H₂ from the gas mixture with a pressure reduction of 90 kPa. The g-FTIR spectrum in FIG. 4a (iii) of the remaining gas after 2 hours of milling treatment indicates that both gases are present, but only CH₄ was detected in the FTIR spectrum of the remaining gas after 4 hours of milling (FIG. 4a (iv)). This process can also be applied to separate C₂H₄ and C₂H₆, which is another industry product requiring purification.

BN powders were milled in the presence of C₂H₄ (20 vol %) and C₂H₆ (80 vol %). A pressure decreases of 60 kPa was observed after 2 hours of milling. Comparing the g-FTIR spectrum of the gas mixture after 2 hours of milling (FIG. 4b (iv)) to the g-FTIR spectra of the individual gases and the initial gas mixture (FIG. 4b (i-iii)) indicates that only C₂H₆ was present in the remaining gas, indicating that C₂H₄ was successfully removed. The separation of C₂H₄ and C₂H₆ was confirmed after milling for 4 hours (FIG. 4b (v)). The FTIR spectrum of the BN sample milled in the gas mixture for 2 hours (FIG. 5b (i)) revealed that C₂H₄ adsorbed onto the BN sample. The adsorbed C₂H₄ gas was extracted by heating the milled BN to 550° C., and the g-FTIR spectrum of the released gas confirmed that it was C₂H₄ (FIG. 5b (ii)).

Furthermore, this technology also can separate CO₂ from CH₄ and N₂ gas mixtures. FIG. 4c shows g-FTIR of initial CO₂/CH₄ gas mixture and remaining gases after regular time intervals. In FIG. 4d, gas chromatograms confirm separation of CO₂ from N₂ occurs after 5 h of milling.

### Example 5—Proposed Gas Storage Mechanism

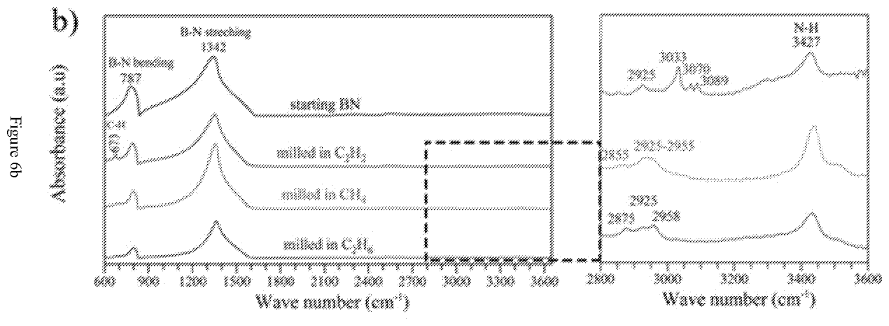

The adsorption of C₂H₄ molecules as an example gas onto BN samples was further investigated by Fourier Transform Infrared Spectroscopy (FTIR). The FTIR spectra shown in FIG. 6a are partial spectra covering the fingerprint region (2700-3150 cm⁻¹) of hydrocarbon molecules. The featureless FTIR spectrum (FIG. 6a (i)) confirms that the initial BN powder did not contain any adsorbed C₂H₄. The FTIR spectrum of the BN sample after 20 hours of continuous milling in the presence of C₂H₄ (FIG. 6a (ii)) shows two peaks at 2850 cm⁻¹ and 2920 cm⁻¹, which represent sp³ C—H stretching of the adsorbed C₂H₄ molecules.

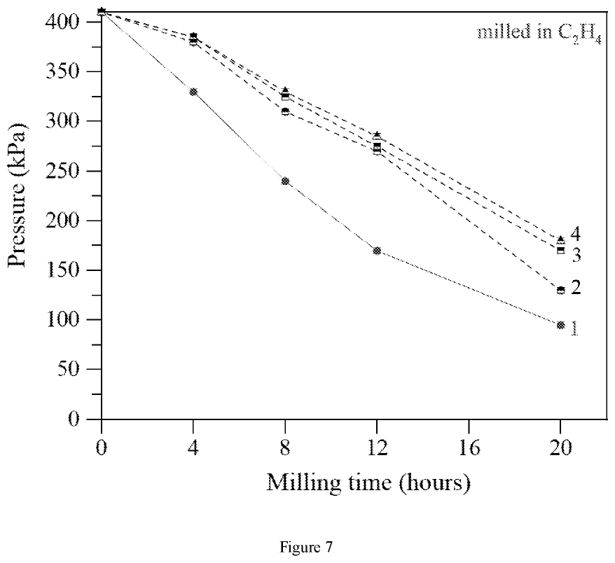

To further confirm C₂H₄ adsorption, the milled BN sample was heated from room temperature to 550° C. at a rate of 25° C./min using a simultaneous thermal analysis (STA)-FTIR coupled system. The resulting spectrum of the gas collected during heating to 550° C. (FIG. 6a (iii)) exhibits the same two characteristic peaks attributed to C₂H₄ molecules, confirming the adsorption of C₂H₄gas. The collected gas from the milling device after heating treatment gives a recovery rate of 82% for C₂H₄. The FTIR of the heated BN (FIG. 6a (iv)) shows that the BN sample was cleaned after the heat treatment and all the adsorbed C₂H₄ have been removed from the BN surface. When the cleaned BN was re-milled in C₂H₄, a similar gas pressure reduction was observed during subsequent milling (FIG. 7), and the same sample was cleaned and milled for 4 cycles with a pressure/capacity reduction less than 100 kPa to the first milling treatment. The re-adsorption of C₂H₄ molecules was confirmed by FTIR (FIG. 6a (v)). The small N—H peak at 3427 cm⁻¹ indicates that there was a weak non-covalent interaction between the hydrogen of the C₂H₄ molecules and the nitrogen in the BN powder. A N—H peak was not observed in the spectra of the released gas (FIG. 6a (iii)). The adsorption of the other hydrocarbon gases by BN during ball milling was also confirmed by FTIR analysis (FIG. 6b). The full FTIR spectra in FIG. 6b shows two characteristic peaks of h—BN at 787 cm⁻¹ and 1336 cm⁻¹ correspond to out-of-plane B—N bending and in-plane B—N stretching, respectively. For the spectrum (i) recorded from the BN milled in C₂H₂ gas, a unique C—H peak at 673 cm⁻¹ is associated with C₂H₂ molecules and does not present in other spectra. Other characteristic C—H peaks have relatively low intensity and thus the spectra of the hydrocarbon fingerprint region are enlarged and displayed in FIG. 6b. The peaks at, 2925, 3033 cm⁻¹, 3070 cm⁻¹, 3089 cm⁻¹ correspond to the sp² C—H stretching of C₂H₂ molecules. The spectra of the BN milled in CH₄ for 20 hours have the characteristic C—H stretch of CH₄ at 2855, 2925 to 2955 cm⁻¹. The peaks at 2875-2958 are C—H stretch of C₂H₆ molecules. The N—H peak at 3427 cm⁻¹ can be seen in all spectra of the BN milled in all gasses, confirming the non-covalent attachment of various gases on BN surface.

Gas adsorption onto BN was achieved at room temperature by mechanical energy via ball milling. The adsorbed gases can be released from the milled sample by heating. The cleaned BN samples can be reused for further adsorption.

The mechanisms underlying gas adsorption on BN during ball milling were investigated. Mechanical grinding of powders can substantially reduce their particle size and increase their surface area; thus, more gas molecules can be physically adsorbed due to the creation of new surfaces.

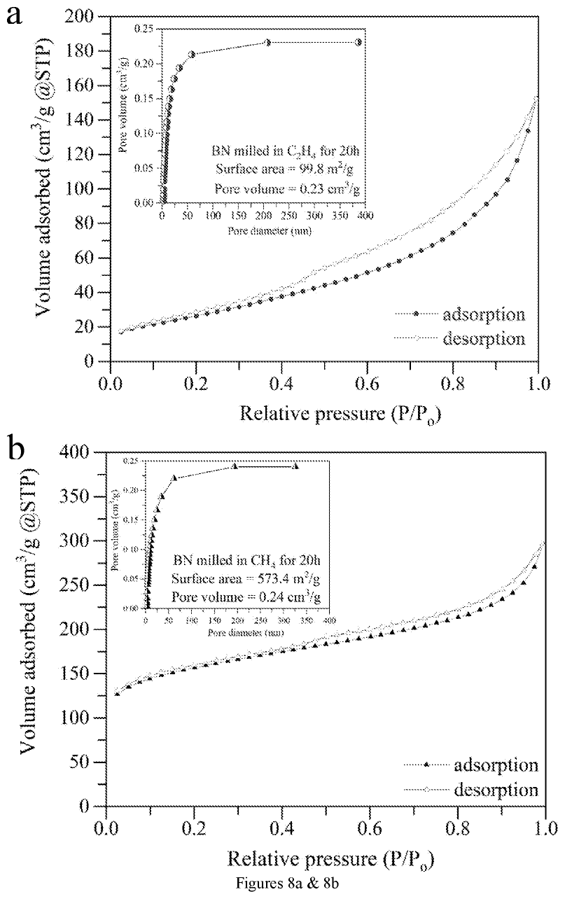

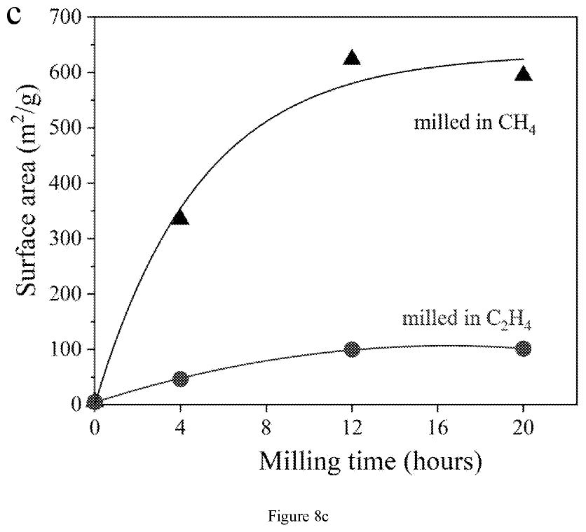

The Brunauer-Emmett-Teller (BET) surface area of the BN powder is displayed in FIG. 8 as a function of milling time. The surface area of BN increased by 623.6 m²/g after 20 hours of milling in CH₄, while a smaller change in surface area (99.8 m²/g) was observed for the BN sample milled in C₂H₄ under the same milling conditions.

FIG. 2a shows that much more C₂H₄ (228 cm³/g) was adsorbed onto the BN with a smaller surface area. In contrast, less CH₄ (152 cm³/g) was adsorbed by BN with a larger surface area.

Without wishing to be limited by theory, those results indicate that adsorption capacity does not depend on the surface area of the BN sample and suggest that the adsorption mechanism for olefin gases cannot be attributed to physical adsorption alone.

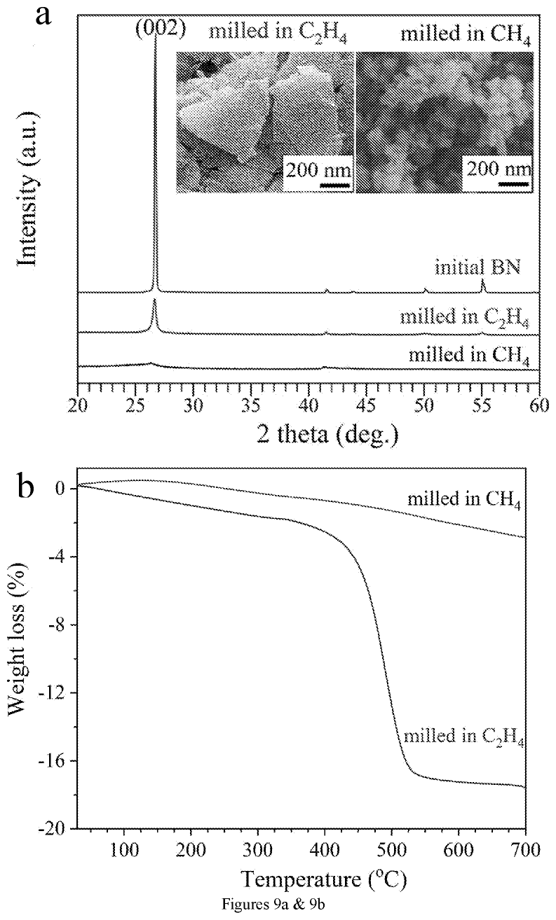

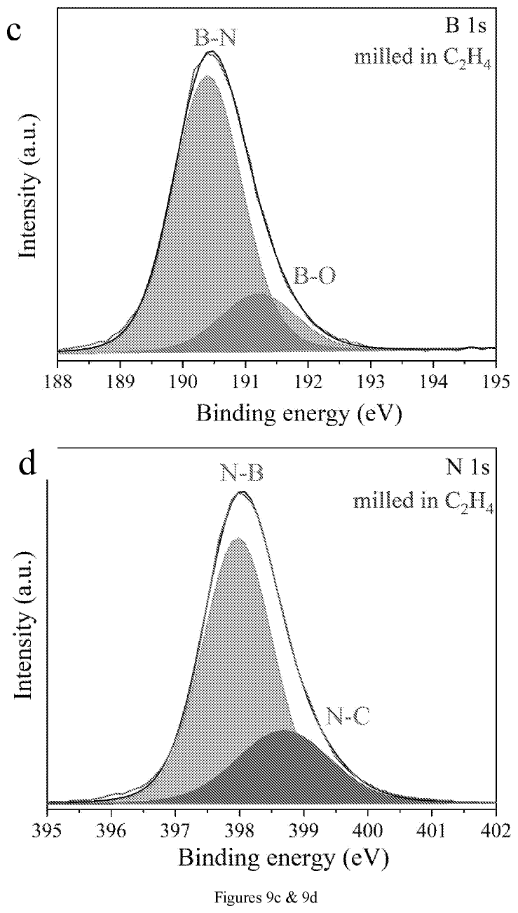

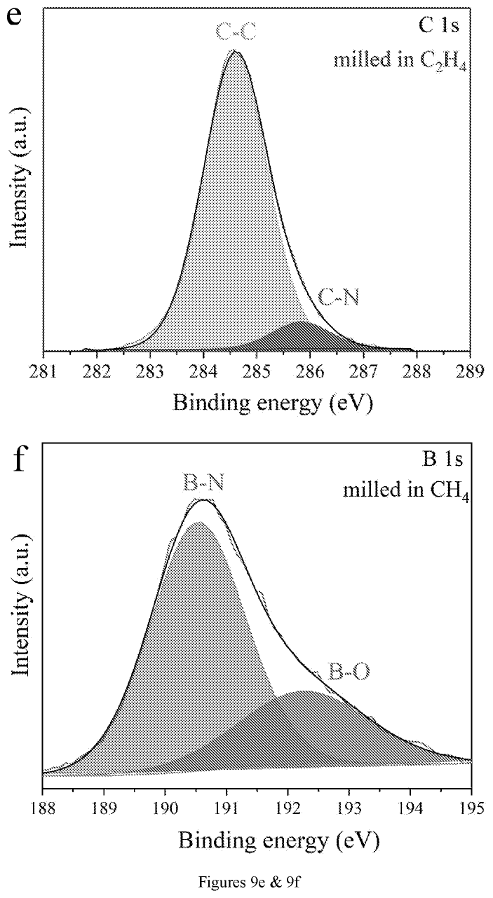

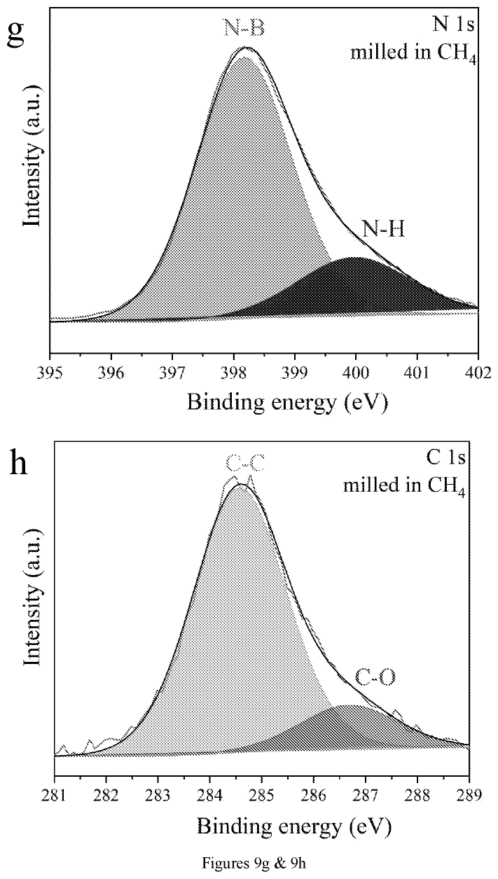

Different crystalline structures in milled BN were found from the X-ray diffraction (XRD) patterns displayed in FIG. 9a, which show that the h—BN sample milled for 20 hours in C₂H₄ maintains the hexagonal crystalline structure of the initial BN powder. However, the h—BN sample milled for the same duration in CH₄ has a disordered structure, as indicated by the decreased intensity and broadening of the (002) diffraction peak of the sample. Scanning electron microscopy (SEM) analysis confirmed the different morphologies of these two samples. The SEM images of the BN samples in FIG. 9a (inset) show that the BN powders milled in the presence of C₂H₄ have nanosheet-like morphologies, with the size of a few micrometers and thicknesses of <30 nm, while the BN powders milled in the presence of CH₄ are spherical shape with diameters of <80 nm.

Corresponding TEM images (FIG. 10 a, b) and the selected area electron diffraction (SAED) patterns show consistent results. BN nanosheets were formed during milling in the olefin gases due to gas adsorption, because these olefin gases are believed to have a lubricating role and prevent crosslinks between different layers, nanosheets were exfoliated and protected by the surface-adsorbed olefin molecules.

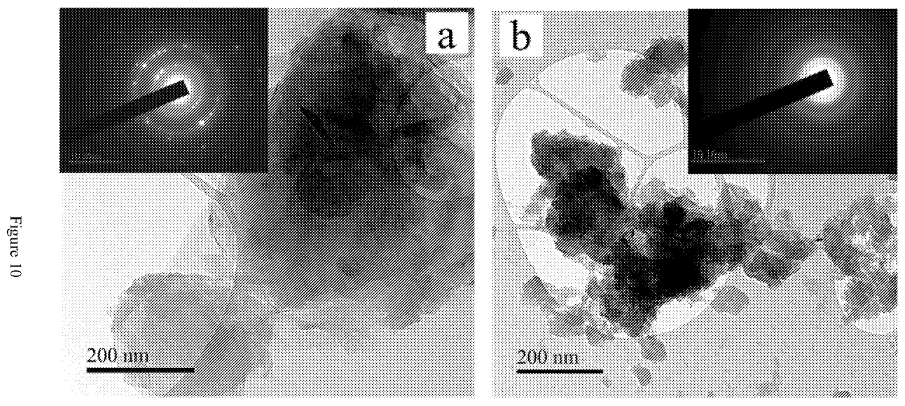

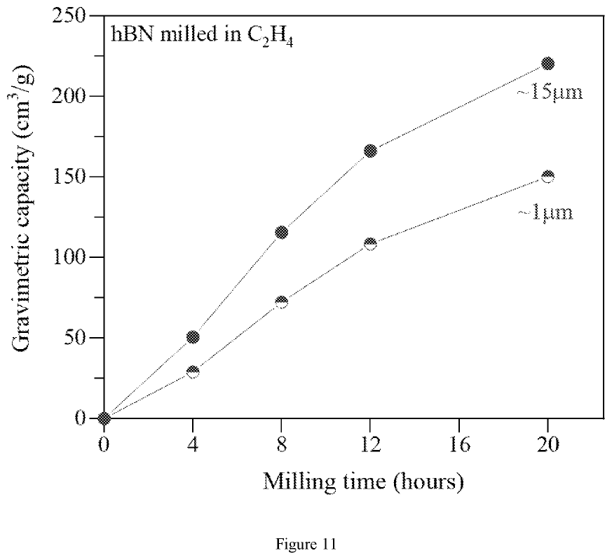

For comparison, the starting hBN of different sizes has been tested (FIG. 11), which confirms that the size is not a key factor for the gas adsorption in the ball milling process.

The different morphologies and crystalline structures of the milled BN samples are believed to indicate that different mechanisms are responsible for the adsorption of olefin and paraffin gases.

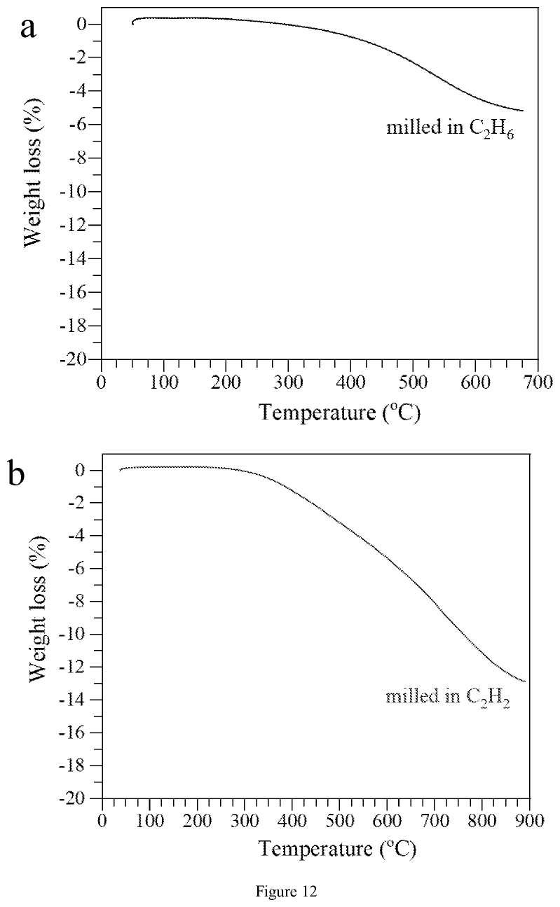

To determine the mechanisms involved in the adsorption of these two different types of gases, the BN samples that were continuously milled for 20 hours in the presence of either CH₄ or C₂H₄ were heated to 700° C. at 25° C./min in a thermal gravimetric analyzer (TGA) under constant argon gas flow (FIG. 9b). The desorption of the previously adsorbed CH₄ occurred gradually, and a total weight loss of 2.8 wt. % was measured, indicating that CH₄ had been physically adsorbed on the BN nanoparticles. Similar gas desorption behavior was observed for C₂H₆ (FIG. 12a).

For BN milled in C₂H₄, the TGA curve showed a gradual weight loss up to 400° C. (2.5 wt. %) due to the release of physically adsorbed gas and then a sharp curve change indicating large and quick weight loss from 400 to 550° C. (14.5 wt. %) (FIG. 9b). This high desorption temperature and narrow temperature range indicate that C₂H₄ was more strongly adsorbed on the BN nanosheets. The desorption temperature range observed was larger than the desorption temperature of C₂H₄ on zeolite (350-380° C.) and defect-laden BN (287° C.). A desorption energy of 88.7 J/g was determined by in-situ differential scanning calorimetry (DSC). A sharp weight loss was also observed in the TGA curve of the BN sample milled in C₂H₂ (FIG. 12b).

Those results are believed to suggest that the two gases (olefin and paraffin) have different adsorption energies with the BN nanosheets after ball milling.

The ball milled BN and was investigated using X-ray photoelectron spectroscopy (XPS). For the BN samples milled in C₂H₄, the B 1s spectrum in FIG. 9c shows the characteristic two B—N peaks at the binding energy of 190.3 eV and 191.1 eV. The N Is spectrum in FIG. 9d displays a dominant N—B binding at 397.9 eV and an N—C binding at 398.6 eV. A small peak at 400.1 eV may be attributed by N—H bonding. Whereas B1s and N1s spectra of starting BN powder indicate BN free from any gas adsorption. The C 1s spectrum in FIG. 9e shows a major peak at 284.5 eV associated with two C—C and C—H bonding from the adsorbed C₂H₄ molecules and a C—N bonding peak at 285.3 eV. The presence of N—C bonding peaks in both N 1s and C 1s spectra and the absence of B—C bonding in B1s spectrum suggest the non-covalent N—C bonding between C₂H₄ molecules and BN nanosheets. Small portion of C₂H₄ is physically absorbed on BN nanosheets via N—H bonding as indicated by the N—H peak in the N 1s spectrum and the corresponding FTIR spectra, which is also consistent with the small weight loss in the low-temperature range <400° C.

For the BN samples milled in CH₄, the B 1s spectrum (FIG. 9f) has two B—N bonding peaks and a large B—O binding peak at 193.1 eV^{[38]}. The milled BN samples have a large surface area and are active in environmental gases and contaminated by the oxygen in the air during XPS analysis. The N 1s spectrum in FIG. 9g has the same N—B bonding peak and a broad and weak shoulder band centered at 399.5 eV, which could be contributed by N—H. The C 1s spectrum in FIG. 9h shows a major peak at 284.5 eV associated with C—C and C—H bindings, and a C—O peak at 286.3 eV. The pronounced N—H bonding peak at 399.5 eV in FIG. 9g is believed to indicate physical absorption of CH₄ molecules onto BN surface via N—H bonding, which is in agreement with FTIR results.

The XPS results reveal that paraffin molecules are adsorbed on the surface of BN nanoparticles via weak N—H bonding. The nitrogen atoms in BN have a high electronegativity, while olefin molecules have unsaturated carbon atoms. Thus, the C₂H₄ has relatively strong adsorption energy towards the BN than CH₄. From the XPS investigation it is beleived the Nitrogen atoms in BN can form non-covalent bonds with unsaturated carbon atoms in the olefin gas of C₂H₄. However, those non-covalent C—N bonds cannot form on BN nanosheets under ambient conditions without the assistance of ball milling actions, which provides energy needed for the unique interaction between BN and gases.

### Example 6—Method to Separate Gas Mixtures

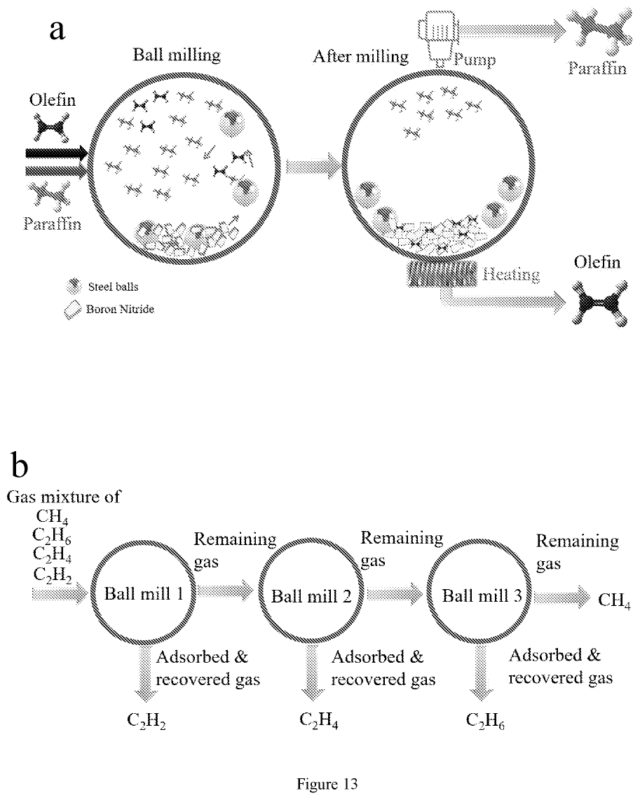

A gas separation process is illustrated in FIG. 13a. When a mixture containing an alkyne or olefin gas (C₂H₂ or C₂H₄) and a paraffin gas (CH₄ or C₂H₆) is introduced into the milling reactor, mechanical milling activates the selective adsorption of the alkyne and olefin gas onto the BN powder. The paraffin gas remains in the reactor chamber and can be removed through a vacuum system. The adsorbed alkyne and olefin gas can be recovered via heating of the milling reactor/BN. The process can be repeated or conducted continuously if fresh gas is supplied continuously. FTIR results in FIG. 4 a-c show that the mechanically enhanced selective adsorption process can effectively separate mixed hydrocarbon gases by removing all olefin gases after a fine-tuned milling treatment (i.e., milling intensity, time and gas pressure). For the case of a mixed gas containing more than two gases, a separation process involving several milling reactors is proposed (FIG. 13b) provided that these gases have different adsorption rates and capacities. The separation efficiency depends on the selective adsorption capability.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A method of promoting adsorption of one or more gases to solid particulate material, the method comprising ball milling the solid particulate material (i) in the presence of the one or more gases maintained at a pressure of at least 300 kPa, (ii) using a weight ratio of milling balls to solid particulate material of at least 60:1, and (iii) at an operating speed of at least 200 rpm; wherein the solid particulate material used does not chemically react with the one or more gases and form a covalent bond with the solid particulate material.

2. The method according to claim 1, wherein the ball milling is conducted at room temperature.

3. The method according to claim 1, wherein the solid particulate material is selected from boron nitride, graphite, molybdenum disulphide, tungsten disulphide, molybdenum diselenide, tungsten diselenide, molybdenum ditelluride, boron, iron, and silicon.

4. The method according to claim 1, wherein the one or more gases is maintained at a pressure of at least about 500 kPa.

5. The method according to claim 1, wherein the weight ratio of milling balls to solid particulate material is at least about 80:1.

6. The method according to claim 1, wherein the operating speed is at least about 300 rpm.

7. The method according to claim 1, wherein before undergoing ball milling the solid particulate material has an average particle size ranging from about 1 μm to about 5 mm.

8. The method according to claim 1, wherein the one or more gases are selected from hydrogen, carbon dioxide, carbon monoxide, C₁-C₄ hydrocarbons, ammonia, nitrogen monoxide, nitrogen dioxide, sulphur dioxide and nitrogen.

9. The method according to claim 1, wherein the ball milling produces as a product the solid particulate material having the one or more gases adsorbed thereto and that product is contained in a vessel to store the one or more gases.

10. The method according to claim 9, wherein the product having the one or more gases adsorbed thereto has a gas adsorption gravimetric capacity of at least 500.

11. The method according to claim 9, wherein the product contained in the vessel is heated to a temperature ranging from about 50° C. to about 500° C. to release the one or more gases adsorbed to the solid particulate material.

12. The method according to claim 1, wherein (i) the ball milling is conducted in the presence of a mixture of two or more gases and it produces as a product the solid particulate material having the mixture of gases adsorbed thereto, and (ii) that product is processed to selectively release at least one adsorbed gas from the solid particulate material, to thereby separate the released gas from the mixture of two or more gases.

13. The method according to claim 1, wherein the ball milling is conducted in the presence of a mixture of two or more gases and it produces as a product the solid particulate material having (i) at least one gas from the mixture of gases adsorbed thereto, and (ii) at least one gas from the mixture of gases not adsorbed thereto, to thereby separate the at least one gas that is not adsorbed from the mixture of two or more gases.
